(19) United States
(12) Patent Application Publication
(10) Pub. No.: US 2014/0152807 A1
(43) Pub. Date: Jun. 5, 2014

(54) SUBSTRATE DEFECT INSPECTION METHOD, SUBSTRATE DEFECT INSPECTION APPARATUS AND NON-TRANSITORY COMPUTER-READABLE STORAGE MEDIUM

(71) Applicant: Tokyo Electron Limited, Tokyo (JP)

(72) Inventors: Shuji IWANAGA, Koshi City (JP); Tadashi NISHIYAMA, Koshi City (JP)

(73) Assignee: Tokyo Electron Limited, Tokyo (JP)

(21) Appl. No.: 14/077,329

(22) Filed: Nov. 12, 2013

(30) Foreign Application Priority Data
Nov. 30, 2012 (JP) 2012-262242

(51) Int. Cl. G01N 21/88

(52) U.S. Cl. CPC G01N 21/8851
USPC 348/125

(57) ABSTRACT

A method of inspecting a substrate for a defect on a basis of a substrate image imaged by an imaging apparatus, includes: imaging a substrate being an imaging object under a predetermined imaging condition; extracting a mode of pixel values of the imaged substrate image; calculating a correction value for the imaging condition on a basis of the extracted pixel value and preset imaging condition correction data; then changing the imaging condition on a basis of the correction value, and imaging again the substrate being the imaging object under the changed imaging condition; and inspecting the substrate for a defect on a basis of a substrate image imaged under the changed imaging condition.

### BACKGROUND OF THE INVENTION

1. Field of the Invention

The present invention relates to a method of inspecting a substrate for a defect on the basis of a substrate image imaged by an imaging apparatus, a substrate defect inspection apparatus and a non-transitory computer readable storage medium.

This application is based upon and claims the benefit of priority of the prior Japanese Patent Application No. 2012-262242, filed in Japan on Nov. 30, 2012, the entire contents of which are incorporated herein by reference.

2. Description of the Related Art

In photolithography processes in a manufacture process of a semiconductor device, for example, a series of treatments such as a resist coating treatment of applying a resist solution onto a wafer to form a resist film, an exposure treatment of exposing the resist film to a predetermined pattern, a developing treatment of developing the exposed resist film and so on are performed in sequence to form a predetermined resist pattern on the wafer. The series of treatments are performed in a coating and developing treatment system being a substrate treatment system including various treatment units that treat the wafer, transfer mechanisms that transfer the wafer and so on.

One of defects occurring on the wafer which has been treated in the coating and developing treatment system is defocus defect caused by defocus during the exposure treatment. The main cause of the defocus defect is that a stage of an exposure apparatus is contaminated with particles. The contamination of the stage is caused, in particular, by particles adhering to the rear surface of the wafer transferred into the exposure apparatus. For this reason, the wafer before transferred into the exposure apparatus needs to have a clean rear surface.

Regarding this point, Japanese Laid-open Patent Publication No. 2008-135583 suggests a substrate treatment system including a cleaning unit that cleans the rear surface of the wafer to keep the rear surface of the wafer transferred into the exposure apparatus clean and an inspection unit that images the cleaned rear surface of the wafer with an imaging apparatus such as a CCD line sensor.

### SUMMARY OF THE INVENTION

In the above-described imaging of the wafer, it is sometimes impossible to determine a defect of the wafer if the luminance (pixel value) of the imaged image is too high or too low. Therefore, the illuminance of illumination at which the wafer is illuminated is adjusted so that the luminance of the image of the wafer becomes optimal luminance for defect determination.

Incidentally, various rear surface films are formed on the rear surface of the wafer and the reflectance of the rear surface of the wafer is different depending on the kind of the film to be formed thereon. Therefore, in imaging of the rear surface of the substrate, an imaging recipe in which an imaging condition such as the illuminance and the scan speed is optimized is prepared for each kind of rear surface film.

For preparation of the recipe, an operator conventionally sets the imaging condition on the basis of the empirical rules and so on at the beginning. Then, the operator checks the substrate image imaged under the imaging condition, corrects the imaging condition in a trial-and-error manner, and prepares a final recipe. Thus, a lot of time is required for preparation of the recipe in which the imaging condition is set. Particularly, since the large item and small scale production is mainstream in recent years, the amount of time spent on the preparation of the recipe significantly increases.

The present invention has been made in consideration of the above points and its object is to set an optimal imaging condition without preparing any recipe beforehand in substrate defect inspection.

To achieve the above object, the present invention is a method of inspecting a substrate for a defect on a basis of a substrate image imaged by an imaging apparatus, including: imaging a substrate being an imaging object under a predetermined imaging condition; extracting a mode of pixel values of the imaged substrate image; calculating a correction value for the imaging condition on a basis of the extracted pixel value and preset imaging condition correction data; changing the imaging condition on a basis of the correction value, and imaging again the substrate being the imaging object under the changed imaging condition; and inspecting the substrate for a defect on a basis of a substrate image imaged under the changed imaging condition.

According to the present invention, since the correction values for the imaging condition are calculated on the basis of the mode of the pixel values of the substrate image and the imaging condition is set on the basis of the correction values, it is possible to set an optimal imaging condition without preparing any recipe beforehand through trial and error as in the past. Consequently, the inspection of the rear surface of the substrate can be appropriately performed without spending time on the preparation of the recipe.

The present invention according to another aspect is a non-transitory computer readable storage medium storing a program for causing a computer to execute a method of inspecting a substrate for a defect on a basis of a substrate image imaged by an imaging apparatus, the substrate inspection method including: imaging a substrate being an imaging object under a predetermined imaging condition; extracting a mode of pixel values of the imaged substrate image; calculating a correction value for the imaging condition on a basis of the extracted pixel value and preset imaging condition correction data; changing the imaging condition on a basis of the correction value, and imaging again the substrate being the imaging object under the changed imaging condition; and inspecting the substrate for a defect on a basis of a substrate image imaged under the changed imaging condition.

The present invention according to still another aspect is an apparatus for inspecting a substrate for a defect, including: an imaging apparatus configured to image the substrate; a pixel value extraction part configured to extract, from a substrate image imaged by the imaging apparatus under a predetermined imaging condition, a mode of pixel values of the substrate image; a correction value calculation part configured to calculate a correction value for the imaging condition on a basis of the extracted pixel value and preset imaging condition correction data; and an imaging condition changing part configured to change the imaging condition on a basis of the correction value.

According to the present invention, it is possible to set an optimal imaging condition without preparing any recipe beforehand in substrate defect inspection.

### BRIEF DESCRIPTION OF THE DRAWING

FIG. 1 is a plan view illustrating the outline of an internal configuration of a substrate treatment system according an embodiment;

FIG. 2 is a side view illustrating the outline of the internal configuration of the substrate treatment system according this embodiment;

FIG. 3 is a side view illustrating the outline of the internal configuration of the substrate treatment system according this embodiment;

FIG. 4 is a transverse sectional view illustrating the outline of a configuration of a defect inspection unit;

FIG. 5 is a longitudinal sectional view illustrating the outline of the configuration of the defect inspection unit;

FIG. 6 is an explanatory view illustrating the outline of a configuration of an imaging condition setting mechanism;

FIG. 7 is an explanatory view exemplifying the histogram of a substrate image;

FIG. 8 is an explanatory view exemplifying a correction value calculation table;

FIG. 9 is an explanatory view exemplifying a substrate image having the optimal luminance;

FIG. 10 is an explanatory view exemplifying a substrate image which is too high in luminance;

FIG. 11 is an explanatory view exemplifying a substrate image having a luminance higher than the optimal luminance;

FIG. 12 is a flowchart illustrating main steps of the defect inspection of a wafer;

FIG. 13 is an explanatory view exemplifying a substrate image; and

FIG. 14 is an explanatory view exemplifying a substrate image.

### DETAILED DESCRIPTION OF THE INVENTION

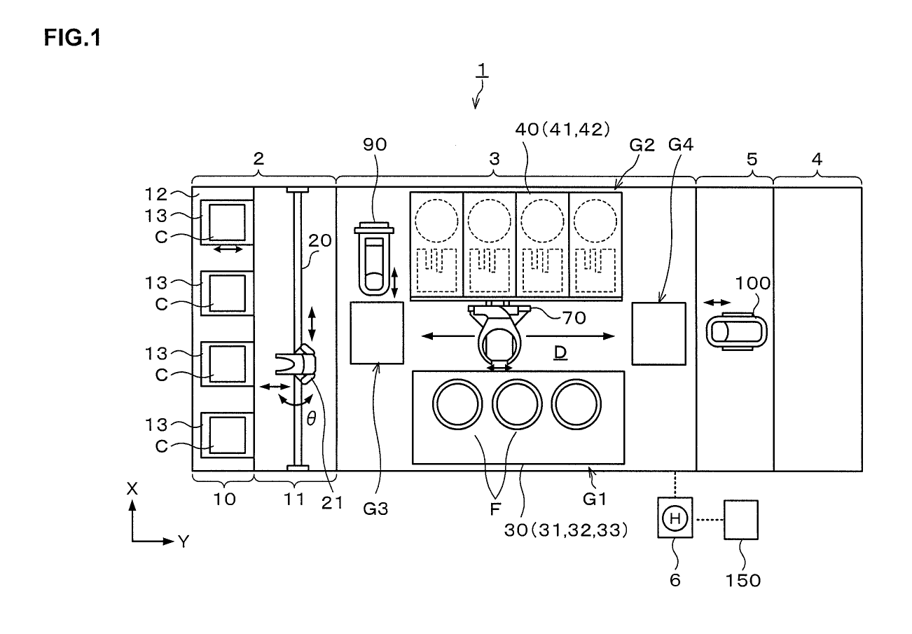

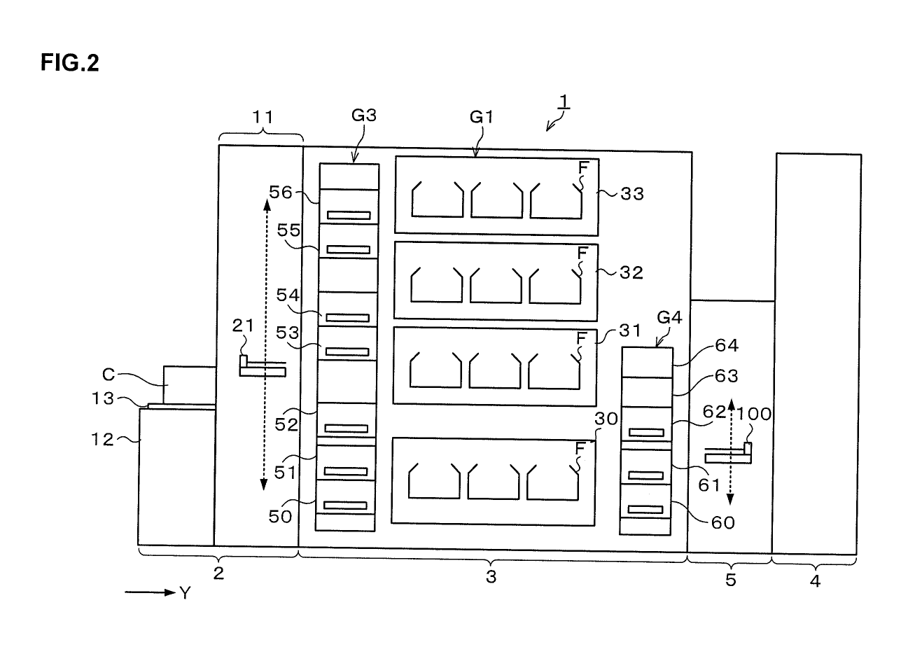

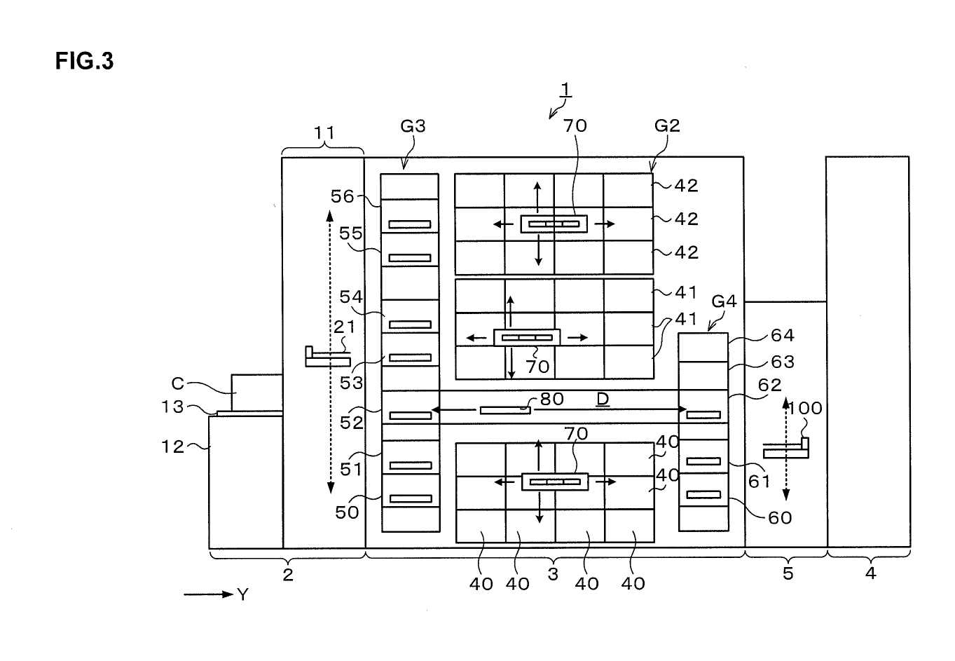

Hereinafter, an embodiment of the present invention will be described. FIG. 1 is an explanatory view illustrating the outline of an internal configuration of a substrate treatment system 1 including a defect inspection apparatus according to this embodiment. FIG. 2 and FIG. 3 are side views illustrating the outline of the internal configuration of the substrate treatment system 1. Note that a case where the substrate treatment system 1 is a coating and developing treatment system that performs, for example, photolithography processing on the substrate will be described as an example in this embodiment.

The substrate treatment system 1 has, as illustrated in FIG. 1, a configuration in which, for example, a cassette station 2 as a transfer-in/out section into which a cassette C is transferred in/out from/to, for example, the outside, a treatment station 3 as a treatment section which includes a plurality of various kinds of treatment units that perform predetermined treatments in a manner of single wafer treatment in a photolithography process, and an interface station 5 as a transfer section that delivers the wafer W to/from an exposure apparatus 4 adjacent to the treatment station 3, are integrally connected. The substrate treatment system 1 also has a control unit 6 that performs control of the substrate treatment system 1. To the control unit 6, a later-described imaging condition setting mechanism 150 is connected.

The cassette station 2 is divided, for example, into a cassette transfer-in/out section 10 and a wafer transfer section 11. For example, the cassette transfer-in/out section 10 is provided on the end portion on a Y-direction negative direction (a left direction in FIG. 1) side of the substrate treatment system 1. In the cassette transfer-in/out section 10, a cassette mounting table 12 is provided. On the cassette mounting table 12, a plurality of, for example, four mounting plates 13 are provided. The mounting plates 13 are provided, arranged side by side in a line in an X-direction (a top and bottom direction in FIG. 1) being the horizontal direction. On the mounting plates 13, cassettes C can be mounted when the cassettes C are transferred in/out from/to the outside of the substrate treatment system 1.

In the wafer transfer section 11, a wafer transfer apparatus 21 is provided which is movable on a transfer path 20 extending in the X-direction as illustrated in FIG. 1. The wafer transfer apparatus 21 is movable also in the vertical direction and around a vertical axis (in a θ-direction), and can transfer the wafer W between the cassette C on each of the mounting plates 13 and a later-described delivery unit in a third block G3 in the treatment station 3.

In the treatment station 3, a plurality of, for example, four blocks G1, G2, G3, G4 are provided each including various units. On the front side (an X-direction negative direction side in FIG. 1) in the treatment station 3, the first block G1 is provided, and on the rear side (an X-direction positive direction side in FIG. 1) in the treatment station 3, the second block G2 is provided. Further, on the cassette station 2 side (the Y-direction negative direction side in FIG. 1) in the treatment station 3, the third block G3 is provided, and on the interface station 5 side (a Y-direction positive direction side in FIG. 1) in the treatment station 3, the fourth block G4 is provided.

In the first block G1, as illustrated in FIG. 2, a plurality of solution treatment units, for example, a developing treatment unit 30 that performs developing treatment on the wafer W, a lower anti-reflection film forming unit 31 that forms an anti-reflection film under a resist film of the wafer W (hereinafter, referred to as a “lower anti-reflection film”), a resist coating unit 32 that applies a resist solution to the wafer W to form a resist film, and an upper anti-reflection film forming unit 33 that forms an anti-reflection film over the resist film of the wafer W (hereinafter, referred to as an “upper anti-reflection film”), are four-tiered in order from the bottom.

Each of the units 30 to 33 in the first block G1 has a plurality of cups F, each of which houses the wafer W therein at treatment, in the horizontal direction and can treat a plurality of wafers W in parallel.

In the second block G2, as illustrated in FIG. 3, thermal treatment units 40 each of which performs heat treatment and cooling treatment on the wafer W, adhesion units 41 as hydrophobic treatment apparatuses each of which performs hydrophobic treatment on the wafer W, and edge exposure apparatuses 42 each of which exposes the outer peripheral portion of the wafer W are arranged one on top of the other in the vertical direction and side by side in the horizontal direction. Note that the numbers and the arrangement of the thermal treatment units 40, adhesion units 41, and edge exposure units 42 can be arbitrarily selected.

In the third block G3, a plurality of delivery units 50, 51, 52, 53, 54, 55, 56 are provided in order from the bottom. Further, in the fourth block G4, a plurality of delivery units 60, 61, 62, a defect inspection unit 63 as a defect inspection apparatus that inspects a rear surface of the wafer W for presence or absence of defects, and a rear surface cleaning unit 64 that cleans the rear surface of the wafer W before transferred into the exposure apparatus 4 are provided in order from the bottom.

A wafer transfer region D is formed in a region surrounded by the first block G1 to the fourth block G4 as illustrated in FIG. 1. In the wafer transfer region D, for example, a wafer transfer apparatus 70 is disposed.

The wafer transfer apparatus 70 has a transfer arm that is movable, for example, in the Y-direction, the forward and backward direction, the θ-direction, and the up and down direction. The wafer transfer apparatus 70 can move in the wafer transfer region D to transfer the wafer W to a predetermined unit in the first block G1, the second block G2, the third block G3 and the fourth block G4 therearound. A plurality of the wafer transfer mechanisms 70 are arranged, for example, one above the other as illustrated in FIG. 3 and can transfer the wafers W, for example, to predetermined units in the blocks G1 to G4 at about the same levels as them.

Further, in the wafer transfer region D, a shuttle transfer apparatus 80 is provided which linearly transfers the wafer W between the third block G3 and the fourth block G4.

The shuttle transfer apparatus 80 is configured to be linearly movable, for example, in the Y-direction in FIG. 3. The shuttle transfer apparatus 80 can move in the Y-direction while supporting the wafer W and transfer the wafer W between the delivery unit 52 in the third block G3 and the delivery unit 62 in the fourth block G4.

As illustrated in FIG. 1, a wafer transfer apparatus 90 is provided on the X-direction positive direction side of the third block G3. The wafer transfer apparatus 90 has a transfer arm that is movable, for example, in the forward and backward direction, the θ-direction, and the up and down direction. The wafer transfer apparatus 90 can move up and down while supporting the wafer W to transfer the wafer W to each of the delivery units in the third block G3.

In the interface station 5, a wafer transfer apparatus 100 is provided. The wafer transfer apparatus 100 has a transfer arm that is movable, for example, in the forward and backward direction, the θ-direction, and the up and down direction. The wafer transfer apparatus 100 can transfer the wafer W to each of the delivery units in the fourth block G4 and the exposure apparatus 4 while supporting the wafer W by the transfer arm.

Next, the configuration of the defect inspection unit 63 will be described.

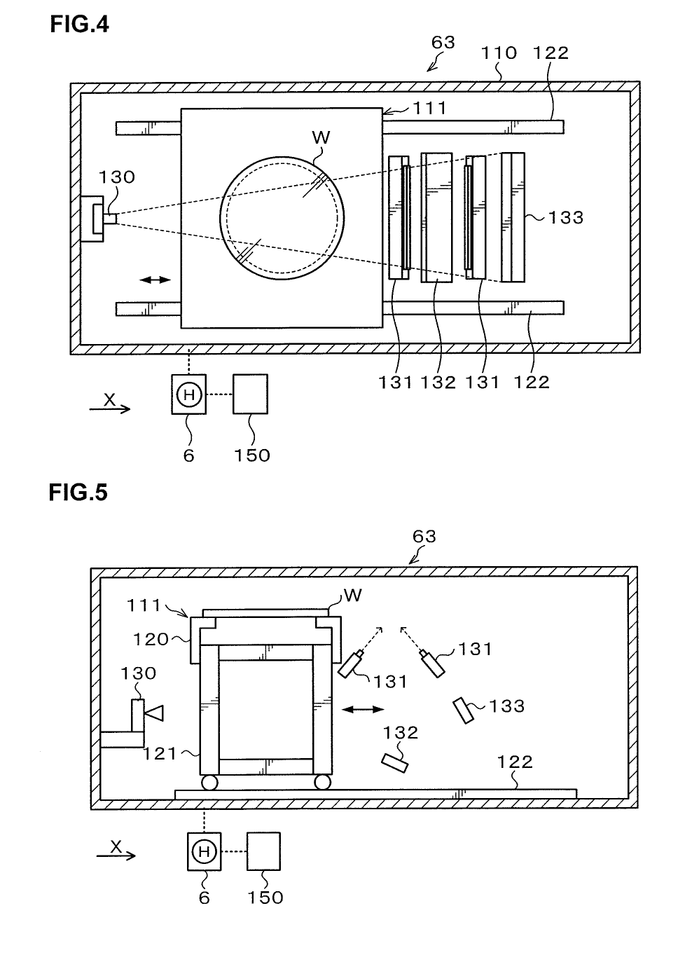

The defect inspection unit 63 has a casing 110 as illustrated in FIG. 4. In the casing 110, a mounting table 111 on which the wafer W is mounted is provided as illustrated in FIG. 5. The mounting table 111 has a holding part 120 that holds the outer peripheral portion of the wafer W with the rear surface of the wafer W directed downward, and a support member 121 that supports the holding part 120. On the bottom surface of the casing 110, guide rails 122, 122 are provided which extend from one end side (an X-direction negative direction side in FIG. 5) to the other end side (an X-direction positive direction side in FIG. 5) in the casing 110. The support member 121 is configured to be movable on the guide rails 122, 122 by means of a not-illustrated drive mechanism.

An imaging apparatus 130 is provided on a side surface on the one end side (the X-direction negative direction side in FIG. 5) inside the casing 110. For example, a wide-angle CCD camera is used as the imaging apparatus 130, and will be described in this embodiment taking a case, as an example, in which the image is monochrome having a number of bits of 8 (256 gradations from 0 to 255). Further, the defect inspection unit 63 is provided with the imaging condition setting mechanism 150 that sets the imaging condition when imaging the rear surface of the wafer W by the imaging apparatus 130. The details of the imaging condition setting mechanism 150 will be described later.

In a region between the guide rails 122, 122 and below the wafer W held by the holding part 120, for example, two illumination devices 131, 131 are provided. The illumination devices 131, 131 are configured to be able to irradiate an area wider than the diameter of the wafer held by the holding part 120. For the illumination devices 131, 131, for example, LEDs are used. The illumination devices 131, 131 are arranged to face each other and irradiate an obliquely upper part so that the height where optical axes of the illumination devices 131, 131 intersect substantially coincides with the height of the rear surface of the wafer W held by the holding part 120. Therefore, light beams radiated from the illumination devices 131, 131 irradiate substantially the same position on the rear surface of the wafer W.

In a region between the guide rails 122, 122 and vertically below the position where the optical axes of the illumination devices 131, 131 intersect, a mirror 132 is provided. The mirror 132 is disposed to be inclined downward, for example, at 22.5 degrees from the horizontal position in a direction opposite to the imaging apparatus 130. Further, in front of the imaging apparatus 130 and at a position obliquely upward at 45 degrees from the mirror 132, a mirror 133 is provided. The mirror 133 is disposed to be inclined downward, for example, at 22.5 degrees from the vertical position in a direction of the bottom surface of the casing 110. Accordingly, the light beams from the illumination devices 131, 131 and reflected off the rear surface of the wafer W are reflected while changing in direction by 45 degrees each by the mirror 132 and the mirror 133, and then captured into the imaging apparatus 130. More specifically, a position vertically above the mirror 132 is within an imaging viewing field of the imaging apparatus 130. Therefore, by moving the mounting table 111 in one direction along the guide rails 122, 122 to cause the wafer W held by the mounting table 111 to cross the position above the mirror 132, the entire rear surface of the wafer W can be imaged by the imaging apparatus 130. Further, by moving the mounting table 111 in the opposite direction after the mounting table 111 is moved in the one direction and imaging is performed, the rear surface of the wafer W can be imaged again. In other words, the rear surface of the wafer W can be imaged twice by reciprocating the mounting table 111 across the position above the mirror 132 within the imaging viewing field of the imaging apparatus 130.

The imaged image of the wafer W (substrate image) is inputted into the imaging condition setting mechanism 150 via the control unit 6. Note that it is not always necessary to provide the two illumination devices 131, but the arrangement and the number of the installed illumination devices 131 can be arbitrarily set as long as it is possible to appropriately irradiate the rear surface of the wafer W with light. Further, as for the mirrors 132, 133, one mirror inclined at 45 degrees may be provided vertically below the position where the optical axes of the illumination devices 131, 131 intersect, and the arrangement and the number of the installed mirrors 132, 133 can be arbitrarily set.

The control unit 6 is composed of a computer including, for example, a CPU, a memory and so on and has a program storage part (not illustrated). In the program storage part, a program that controls rear surface inspection of the wafer W performed on the basis of the substrate image imaged by the defect inspection unit 63 and an imaging condition when imaging the wafer W in the defect inspection unit 63 are stored as programs. In addition, programs for implementing predetermined operations in the substrate treatment system 1, namely, application of a resist solution to the wafer W, development, heat treatment, delivery of the wafer W, control of the units by controlling the actions of the above-described various treatment units and the drive system such as the transfer apparatuses are also stored in the program storage part. Note that the programs may be those stored, for example, in a computer-readable storage medium H such as a hard disk (HD), compact disk (CD), magneto-optical disk (MO) or memory card and installed from the storage medium H into the control unit 6.

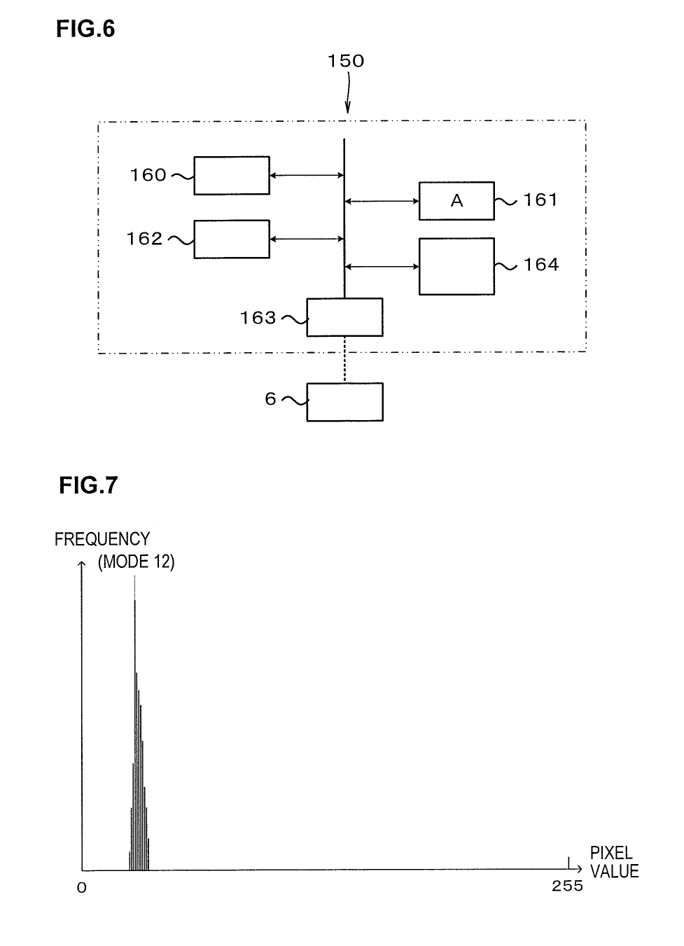

Next, the imaging condition when performing imaging in the defect inspection unit 63 is set. The configuration of the imaging condition setting mechanism 150 will be described. The imaging condition setting mechanism 150 is composed of a general-purpose computer including, for example, a CPU, a memory and so on. The imaging condition setting mechanism 150 includes, for example, as illustrated in FIG. 6, a pixel value extraction part 160 that extracts a mode of pixel values of the substrate image from the substrate image imaged by the imaging apparatus 130, a correction value calculation part 161 that calculates correction values for the parameter setting of the imaging condition on the basis of the pixel value extracted by the pixel value extraction part 160, and an imaging condition changing part 162 that changes the parameter setting of the imaging condition on the basis of the correction values calculated by the correction value calculation part 161. In the imaging condition setting mechanism 150, a communication part 163 that inputs/outputs various kinds of information from/to the control unit 6 and an output and display part 164 that outputs and displays the substrate image and the like are also provided.

The pixel value extraction part 160 digitizes the substrate image inputted from the control unit 6 into the imaging condition setting mechanism 150 as pixel values, for example, in a pixel unit. Subsequently, the pixel value extraction part 160 extracts a pixel value being the mode from the pixel values. Concretely explaining the extraction of the pixel value being the mode using a histogram, in the case where the pixel values of the substrate image exhibit a distribution as illustrated in FIG. 7, “12” that is the most frequent value is the mode. Accordingly, in the case illustrated in FIG. 7, “12” is extracted by the pixel value extraction part 160 as the pixel value being the mode.

Note that the rear surface of the wafer W has not been subjected to special treatment, unlike the front surface, except for formation of a rear surface film and therefore has less change in pixel value within the wafer. For this reason, it is only necessary to extract the mode of the pixel values, for example, from the pixel values of the substrate image in a central area of the wafer W. The central area here does not always mean only the vicinity of the center position of the wafer W, but can be arbitrarily set in any range as long as it does not include the outer peripheral end portion of the substrate image. The reason why the outer peripheral end portion of the wafer W is excluded is that pixel values not reflecting the reflectance at the central area of the wafer W may be detected due to the light scattered at the outer peripheral end portion of the wafer W.

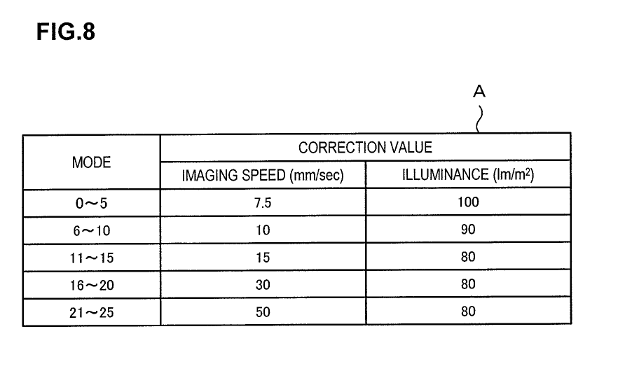

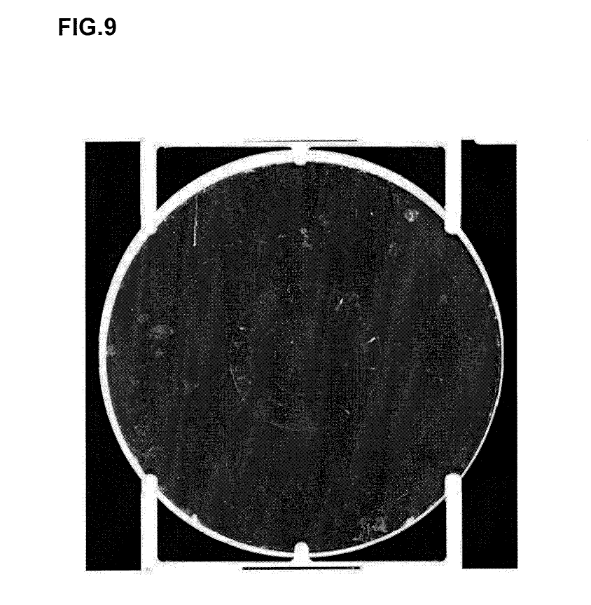

The correction value calculation part 161 has previously stored, for example, a correction value calculation table A as imaging condition correction data illustrated in FIG. 8 for optimizing the imaging condition in the imaging apparatus 130. The correction value calculation table A will be concretely described.

The correction value calculation table A represents the relationship between the mode of the pixel values extracted by the pixel value extraction part 160 when the rear surface of the wafer W is imaged by the imaging apparatus 130 under the predetermined imaging condition and values of parameters which are to be changed to optimize the imaging condition on the basis of the extracted mode after correction (correction values). In this embodiment, for example, the imaging speed by the imaging apparatus 130 is set to 130 [mm/sec] and the illuminance of light beams from the illumination devices 131, 131 is set to 80 [lm/m²]. Note that the imaging speed means the moving speed of the wafer W when the wafer W is scanned above the mirror 132.

As illustrated in FIG. 8, the range of the mode extracted by the pixel value extraction part 160 is set in the field of “mode,” and the imaging speed ranging from “7.5 [mm/sec] to 50 [mm/sec]” and the illuminance ranging from “100 [lm/m²] to 80 [lm/m²]” at which an optimal substrate image can be obtained when the mode is extracted are set in the fields of “correction values.” Further, as illustrated in FIG. 8, the “correction values” of the imaging condition are set such that as the value of the “mode” is smaller, the mode of the pixel values (luminance) of the imaged image imaged under the imaging condition changed on the basis of the “correction values” becomes larger.

Then, the correction value calculation part 161 calculates the correction values on the basis of the correction value calculation table A and the pixel value being the mode extracted by the pixel value extraction part 160. Explaining a case where the mode of the pixel values extracted by the pixel value extraction part 160 is “12” exemplified in FIG. 7 as an example, the correction value calculation part 161 calculates “15” as the correction value for the “imaging speed” and “80” as the correction value for the “illuminance” as the imaging condition from the fields of the “correction values” corresponding to “10 to 15” of the “mode” in the correction value calculation table A.

The correction value calculation table A is obtained by test or the like which has been previously performed. More specifically, a plurality of wafers W having rear surface films different in reflectance formed thereon are prepared, and the rear surface of each of the wafers W is imaged under the above-described predetermined condition. Then, the substrate image obtained by the imaging is checked, the imaging condition is changed according to the luminance of the substrate image, and imaging is performed again. If the substrate image under the changed imaging condition has the desired luminance, the imaging condition at that time is employed as the “correction values.” On the other hand, if the substrate image does not have the desired luminance, the imaging condition is changed again to find the imaging condition at which the desired luminance can be obtained. This operation is performed on the plurality of wafers W to create the correction value calculation table A.

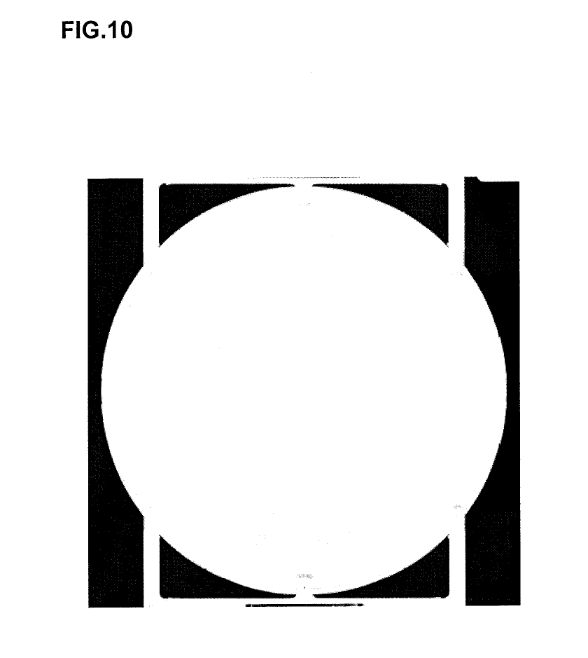

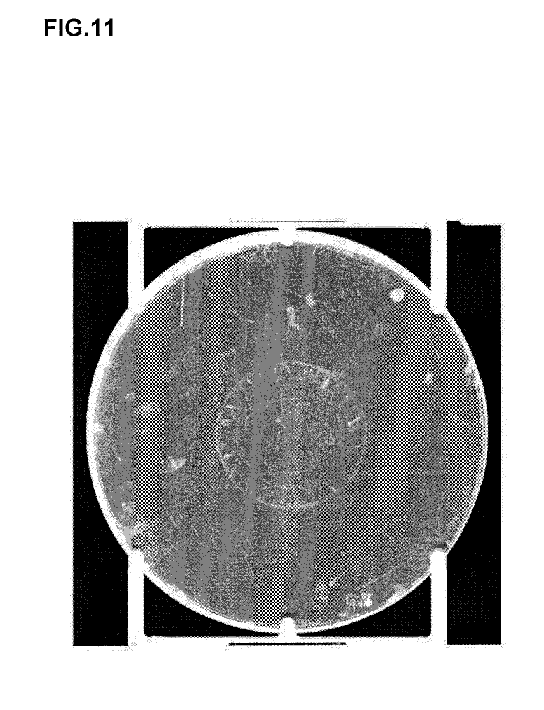

Note that the predetermined imaging condition when creating the correction value calculation table A are preferably set so that the luminance of the substrate image imaged under the predetermined imaging condition is lower than the desired luminance which is optimal for defect inspection because of the following reason. For example, the substrate image illustrated in FIG. 9 is an example of the substrate image having the optimal luminance for defect determination in which defects show white and a portion with no defect shows black. However, when the imaging condition is set so that the substrate image under the predetermined imaging condition becomes brighter than the desired luminance, there is a possibility that the luminance of the substrate image is too high and thus exceeds 255 that is the upper limit of the range of the pixel value as illustrated in FIG. 10. In this case, there is a possibility that if the “correction values” are set so that the pixel values (luminance) of the substrate image imaged under the imaging condition changed on the basis of the “correction values” are smaller than the pixel values of the substrate image in FIG. 10, the luminance of the substrate image imaged under the corrected imaging condition is still higher than the desired luminance. This may cause, for example, the possibility that a portion that is not originally detective also shows white as illustrated in FIG. 11.

Further, the parameters constituting the imaging condition are not limited to those in this embodiment, but are a gain value of the camera begin the imaging apparatus 130 and an aperture (F value) of the lens of the camera other than the above-described imaging speed and illuminance. Further, what parameters are to be employed for the correction value calculation table A can be arbitrarily set, and only the illuminance may be set in the correction value calculation table A.

When the correction value calculation part 161 calculates the correction values, the imaging condition changing part 162 outputs the correction values to the control unit 6 via the communication part 163, whereby each parameter setting of the existing imaging condition in the control unit 6 is changed.

The substrate treatment system 1 according to this embodiment is configured as described above, and treatments on the wafer W performed in the substrate treatment system 1 configured as described above will be described next.

In the treatments on the wafer W, the cassette C housing a plurality of wafers W therein is first mounted on a predetermined mounting plate 13 in the cassette transfer-in/out section 10. Then, the wafers W in the cassette C are sequentially taken out by the wafer transfer apparatus 21 and transferred, for example, to the delivery unit 53 in the third block G3 in the treatment station 3.

Then, the wafer W is transferred by the wafer transfer apparatus 70 to the thermal treatment unit 40 in the second block G2 and temperature-regulated. Thereafter, the wafer W is transferred by the wafer transfer apparatus 70, for example, to the lower anti-reflection film forming unit 31 in the first block G1, in which a lower anti-reflection film is formed on the wafer W. The wafer W is then transferred to the heat treatment unit 40 in the second block G2 and subjected to heat treatment. The wafer W is then returned back to the delivery unit 53 in the third block G3.

Then, the wafer W is transferred by the wafer transfer apparatus 90 to the delivery unit 54 in the same third block G3. Thereafter, the wafer W is transferred by the wafer transfer apparatus 70 to the adhesion unit 41 in the second block G2 and subjected to a hydrophobic treatment. The wafer W is then transferred by the wafer transfer apparatus 70 to the resist coating unit 32, in which a resist film is formed on the wafer W. The wafer W is then transferred by the wafer transfer apparatus 70 to the thermal treatment unit 40 and subjected to pre-baking. The wafer W is then transferred by the wafer transfer apparatus 70 to the delivery unit 55 in the third block G3.

Then, the wafer W is transferred by the wafer transfer apparatus 70 to the upper anti-reflection film forming unit 33, in which an upper anti-reflection film is formed on the wafer W. The wafer W is then transferred by the wafer transfer apparatus 70 to the thermal treatment unit 40, and heated and temperature-regulated. The wafer W is then transferred to the edge exposure unit 42 and subjected to edge exposure processing.

The wafer W is then transferred by the wafer transfer apparatus 70 to the delivery unit 56 in the third block G3.

The wafer W is then transferred by the wafer transfer apparatus 90 to the delivery unit 52 and transferred by the shuttle transfer apparatus 80 to the delivery unit 62 in the fourth block G4. The wafer W is then transferred by the wafer transfer apparatus 100 in the interface station 5 to the rear surface cleaning unit 64 and subjected to rear surface cleaning. The wafer W subjected to rear surface cleaning is transferred by the wafer transfer apparatus 100 to the defect inspection unit 63, in which the rear surface of the wafer W is imaged.

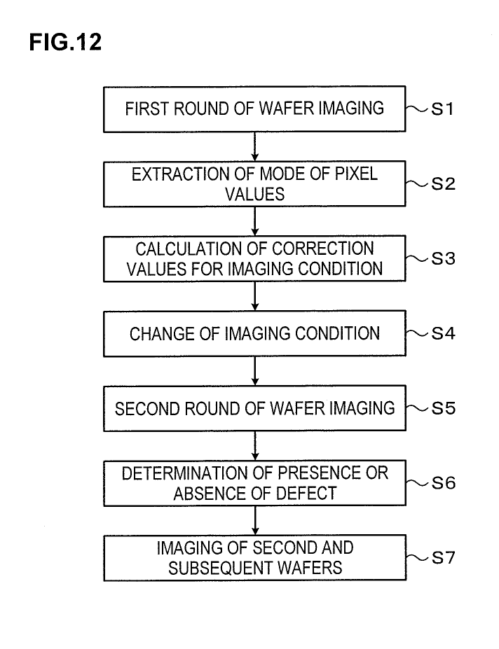

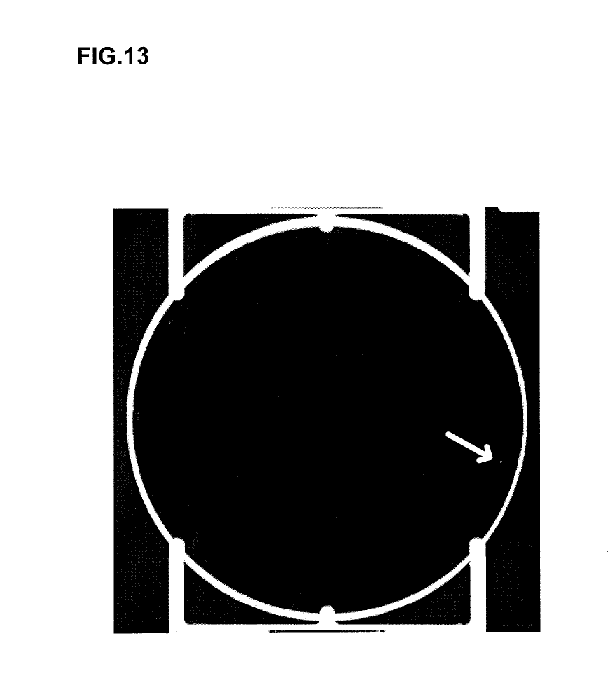

The imaging of the rear surface of the wafer W in the defect inspection unit 63 will be described together with the flowchart of rear surface inspection processing illustrated in FIG. 12.

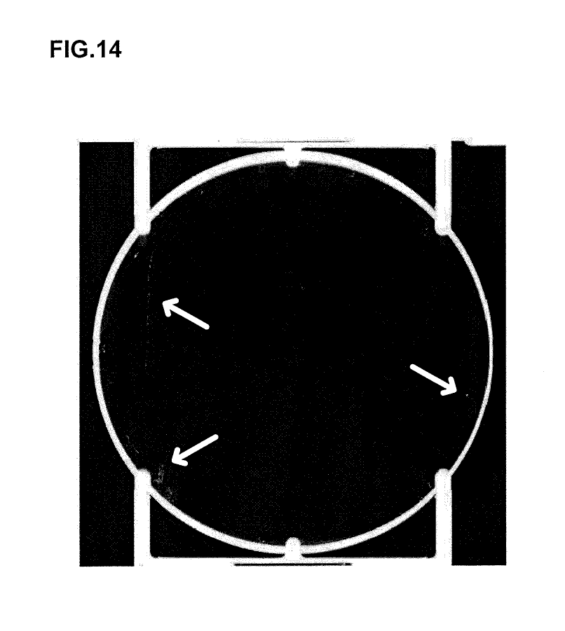

The wafer W transferred into the defect inspection unit 63 is held with the rear surface directed downward by the holding part 120 of the mounting table 111 waiting at the one end side (the X-direction negative direction side in FIG. 5) in the casing 110. Then, the mounting table 111 is moved along the guide rails 122, 122 to the other end side of the casing 110, and the rear surface of the wafer W is imaged by the imaging apparatus 130 (first round of imaging, step S1 in FIG. 12). In this event, as the imaging condition, the imaging speed by the imaging apparatus 130 is set to 130 [mm/sec] and the illuminance of the light beams from the illumination devices 131, 131 is set to 80 [mm/m²]. By the first round of imaging, for example, a substrate image with low luminance as illustrated in FIG. 13 is obtained. In the substrate image with low luminance, only a portion corresponding to a defect shows white at a small part, for example, as illustrated with an arrow in FIG. 13. After the imaging ends, the mounting table 111 is temporarily waits at the other end side of the casing 110.

The imaged substrate image is inputted from the control unit 6 to the imaging condition setting mechanism 150. The pixel value extraction part 160 extracts a mode from the pixel values in the central area of the substrate image (step S2 in FIG. 12). Then, the correction value calculation part 161 calculates the correction values for the imaging speed and the illuminance on the basis of the pixel value being the mode extracted by the pixel value extraction part 160 and the correction value calculation table A (step S3 in FIG. 12). Then, the existing imaging condition in the control unit 6, namely, the imaging speed and the illuminance are changed by the imaging condition changing part 162 (step S4 in FIG. 12).

When the existing imaging condition is changed in the control unit 6, the mounting table 111 waiting at the other end side is moved along the guide rails 122, 122 toward the imaging apparatus 130 of the casing 110. By reciprocating the mounting table 111 along the guide rails 122, 122 as described above, the wafer W is scanned in the direction opposite to that before the change of the imaging condition, and the rear surface of the wafer W is imaged again under the changed imaging condition (second round of imaging, step S5 in FIG. 12). As a result, a substrate image imaged under the optimal imaging condition after correction which has a luminance optimal for check for defect and foreign substance on the rear surface of the wafer W, for example, as illustrated in FIG. 14 is obtained. In the substrate image illustrated in FIG. 14, even defects which cannot be recognized in the substrate image imaged under the imaging condition before correction (the substrate image in FIG. 13) can be recognized.

Then, the control unit 6 determines whether the state of the rear surface of the wafer W allows transfer into the exposure apparatus 4 on the basis of the imaged image obtained by the second round of imaging (step S6 in FIG. 12). Note that the control unit 6 determines whether the wafer W can be exposed in the exposure apparatus 4 on the basis of the number of particles adhering to the rear surface of the wafer W and a range where the particles adhere or the height and size of the particles. Then, when the state of the wafer W is determined that the wafer W can be exposed in the exposure apparatus 4, the wafer W is transferred by the wafer transfer apparatus 100 to the exposure apparatus 4 and subjected to exposure processing.

On the other hand, when the state of the wafer W is determined that the wafer W cannot be exposed, subsequent processing on the wafer W is stopped and the wafer W is transferred by the wafer transfer apparatus 100 to the delivery unit 62 and then transferred by the shuttle transfer apparatus 80 to the delivery unit 52. Thereafter, the wafer for which the subsequent processing is stopped is transferred to the cassette station 2 and then collected into the cassette C on the predetermined mounting plate 13. Note that when it is determined that the wafer W cannot be exposed, the wafer W may be subjected to rear surface cleaning again in the rear surface cleaning unit 64 and inspection again in the defect inspection unit 63.

The wafer W subjected to exposure processing is transferred by the wafer transfer apparatus 100 to the delivery unit 60 in the fourth block G4. Thereafter, the wafer W is transferred by the wafer transfer apparatus 70 to the thermal treatment unit 40 and subjected to post-exposure baking treatment. Thereafter, the wafer W is transferred by the wafer transfer apparatus 70 to the developing treatment unit 30 and developed. After the development is finished, the wafer W is transferred by the wafer transfer apparatus 90 to the thermal treatment unit 40 and subjected to post-baking treatment.

Thereafter, the wafer W is transferred by the wafer transfer apparatus 70 to the delivery unit 50 in the third block G3, and then transferred by the wafer transfer apparatus 21 in the cassette station 2 to the cassette C on the predetermined mounting plate 13. Thus, a series of photolithography processes ends.

Furthermore, the same processing is repeatedly performed on the other wafers W in the same lot housed in the cassette C. In this event, since the same rear surface films are formed on the wafers W in the same lot, change of the imaging condition is unnecessary after the imaging condition is changed once on the basis of the correction values in step S4. More specifically, when imaging the second and subsequent wafers W in the same lot, imaging is continuously performed under the imaging condition after correction in the defect inspection unit 63 (step S7 in FIG. 12). Then, the imaged images of the second and subsequent wafers W are used for determination by the control unit 6 whether the wafers W can be transferred into the exposure apparatus 4, and a series of processing in the defect inspection unit 63 is repeatedly performed on the wafers W in the same lot.

According to the above embodiment, since the correction value calculation part 161 calculates correction values on the basis of the mode of the pixel values extracted by the pixel value extraction part 160 and the imaging condition changing part 162 changes the imaging condition on the basis of the correction values, the optimal imaging condition can be set without previously creating a recipe for the rear surface film of the wafer W that is an imaging object. As a result, even in the case of imaging the rear surface of the wafer W on which, for example, an unknown rear surface film has been formed, the inspection of the rear surface of the wafer can be quickly and appropriately performed without spending time for creating a recipe.

Further, the pixel value extraction part 160 extracts the mode with respect to the pixel values in the central area of the wafer W. This makes it possible to reduce the load due to the calculation in the pixel value extraction part 160 and reduce the time required for extraction of the mode.

In the above embodiment, imaging of the rear surface of the wafer W can be performed twice by reciprocating the mounting table 111 while holding the wafer W by the holding part 120 along the guide rails 122, 122. Therefore, when the imaging condition setting mechanism 150 optimizes the imaging condition, the first round of imaging and the second round of imaging can be speedily performed.

Note that though the case where the imaged image by the CCD camera is monochrome has been described as an example in the above embodiment, the imaged image may be an image composed of three primary colors such as R, G, B. In this case, when extracting the mode of the pixel values, the pixel value extraction part 160 may select, for example, one arbitrary primary color from among R, G, B and extract the mode for the selected primary color.

Though the imaging condition setting mechanism 150 and the control unit 6 are individually provided in the above-described embodiment, the imaging condition setting mechanism 150 may be configured as a part of the control unit 6.

A preferred embodiment of the present invention has been described above with reference to the accompanying drawings, but the present invention is not limited to the embodiment. It should be understood that various changes and modifications are readily apparent to those skilled in the art within the scope of the spirit as set forth in claims, and those should also be covered by the technical scope of the present invention. The present invention is not limited to this embodiment but can take various forms. Though the imaging object is the rear surface of the substrate in the above embodiment, the present invention is also applicable to the case of imaging the front surface of the substrate. Further, though the above-described embodiment is the example in the coating and developing treatment system for the semiconductor wafer, the present invention is also applicable to the case of a coating and developing treatment system for another substrate such as an FPD (Flat Panel Display), a mask reticle for a photomask or the like other than the semiconductor wafer.

What is claimed is:

1. A method of inspecting a substrate for a defect on a basis of a substrate image imaged by an imaging apparatus, comprising:
imaging a substrate being an imaging object under a predetermined imaging condition;
extracting a mode of pixel values of the imaged substrate image;
calculating a correction value for the imaging condition on a basis of the extracted pixel value and preset imaging condition correction data;
changing the imaging condition on a basis of the correction value, and imaging again the substrate being the imaging object under the changed imaging condition; and
inspecting the substrate for a defect on a basis of a substrate image imaged under the changed imaging condition.

2. The substrate defect inspection method according to claim 1,
wherein the imaging condition changed on the basis of the correction value is at least either an imaging speed or illuminance at which the substrate is illuminated.

3. The substrate defect inspection method according to claim 2,
wherein the imaging speed and the illuminance in the predetermined imaging condition are set such that the mode of the pixel values of the substrate image imaged under the predetermined condition is smaller than a mode of pixel values of the substrate image imaged under the imaging condition changed on the basis of the correction value.

4. The substrate defect inspection method according to claim 1,
wherein the mode of the pixel values is extracted from an area excluding an outer peripheral end portion of the substrate image.

5. A non-transitory computer readable storage medium storing a program for causing a computer to execute a method of inspecting a substrate for a defect on a basis of a substrate image imaged by an imaging apparatus,
the substrate inspection method comprising:
imaging a substrate being an imaging object under a predetermined imaging condition;
extracting a mode of pixel values of the imaged substrate image;
calculating a correction value for the imaging condition on a basis of the extracted pixel value and preset imaging condition correction data;
changing the imaging condition on a basis of the correction value, and imaging again the substrate being the imaging object under the changed imaging condition; and
inspecting the substrate for a defect on a basis of a substrate image imaged under the changed imaging condition.

6. An apparatus for inspecting a substrate for a defect, comprising:
an imaging apparatus configured to image the substrate;
a pixel value extraction part configured to extract, from a substrate image imaged by the imaging apparatus under a predetermined imaging condition, a mode of pixel values of the substrate image;
a correction value calculation part configured to calculate a correction value for the imaging condition on a basis of the extracted pixel value and preset imaging condition correction data; and
an imaging condition changing part configured to change the imaging condition on a basis of the correction value.

7. The substrate defect inspection apparatus according to claim 6,
wherein the imaging condition changed on the basis of the correction value is at least either an imaging speed or illuminance at which the substrate is illuminated.

8. The substrate defect inspection apparatus according to claim 7,
wherein the imaging speed and the illuminance in the predetermined imaging condition are set such that the mode of the pixel values of the substrate image imaged under the predetermined condition is smaller than a mode of pixel values of the substrate image imaged under the imaging condition changed on the basis of the correction value.

9. The substrate defect inspection apparatus according to claim 6,
wherein the mode of the pixel values is extracted from an area excluding an outer peripheral end portion of the substrate image.

10. The substrate defect inspection apparatus according to claim 6, further comprising:
a moving mechanism configured to reciprocate the substrate across an imaging viewing field of the imaging apparatus.
